(19) United States
(12) Patent Application Publication
(10) Pub. No.: US 2026/0217237 A1
(43) Pub. Date: Jul. 30, 2026

(54) Method and System for Reliably Detecting Objects in the Surroundings of a Motor Vehicle

(71) Applicant: Robert Bosch GmbH, Stuttgart (DE)

(72) Inventors: Jerg Pfeil, Cleebronn (DE); Thomas Michalke, Weil Der Stadt (DE); Jochen Wieland, Renningen (DE)

(21) Appl. No.: 19/146,013

(22) PCT Filed: Dec. 4, 2023
(86) PCT No.: PCT/EP2023/084049

§ 371 Date: Jul. 7, 2025

(30) Foreign Application Priority Data
Jan. 11, 2023 (DE) 10 2023 200 143.8

(51) Int. Cl. B60W 30/00; B60W 50/06; G01S 13/86; G01S 13/931; G06V 10/44; G06V 10/70; G06V 20/58

(52) U.S. Cl. CPC B60W 30/00; B60W 50/06; G01S 13/931; G06V 10/44; G06V 10/70; G06V 20/58; B60W 2420/403; B60W 2420/408; G01S 13/862; G01S 13/865; G01S 13/867

(57) ABSTRACT

A method is disclosed for reliably detecting objects in the surroundings of a motor vehicle, wherein the motor vehicle features a plurality of different surroundings sensors. The method includes (i) acquiring sensor data by at least one of the plurality of different surroundings sensors, (ii) for each of the at least one of the plurality of different surroundings sensors, respectively detecting objects in the corresponding acquired sensor data, (iii) determining at least one distinctive feature during object detection based on the detected objects, and (iv) for each of the at least one distinctive features, respectively checking the corresponding distinctive feature to reliably detect objects in the surroundings of the motor vehicle.

The invention relates to a method for reliably detecting objects in the surroundings of a motor vehicle and, in particular, to a method for detecting objects in the surroundings of a motor vehicle, with which a high detection rate may be ensured and, at the same time, the number of falsely detected objects may be reduced.

A comprehensive detection of the surroundings of a motor vehicle and in particular of objects, for example, other road users in the surroundings of the motor vehicle, forms the basis for many driver assistance systems and automated driving functions of the motor vehicle. Motor vehicles usually have sensor systems that have the task of detecting objects in their respective detection range. The individual sensor systems each comprise a surroundings sensor and a processing unit, which is designed to analyze data supplied by the surroundings sensor, for example, to detect objects in the data. The surroundings sensors may be video cameras, radars, LIDARs or ultrasonic sensors, for example.

Each of these surroundings sensors is very limited in its respective area of application and, depending on the installation location or current weather conditions, for example, may not be able to provide all the information required about the vehicle surroundings. By combining or merging the information from different environmental sensors, the reliability of the detection of the surroundings of the motor vehicle and thus also the detection of objects in the surroundings of the vehicle may be increased, which, in turn, means that corresponding safety-critical situations may be avoided when controlling a driver assistance system or a driving function based on the detected objects.

In known techniques, objects are detected separately in the sensor data acquired by different surroundings sensors and the individual detection results are then merged using a fusion technique. In particular, in complex, confusing scenarios, however, it is difficult to ensure a high detection rate of objects in the surroundings of the vehicle while keeping the number of incorrectly detected objects low. Consequently, there is a need for improved methods for reliably detecting objects in the surroundings of a vehicle.

A method for checking the plausibility of sensor signals and a method and a device for outputting a trigger signal are known from publication WO 2013/056966 A1, wherein a first sensor element acquires at least a first physical variable and outputs it as a first sensor signal, and wherein a second sensor element acquires a second physical variable correlated to the first physical variable and outputs it as a second sensor signal. In addition, at least the first sensor element features at least one first reliability range with an upper limit and/or a lower limit, which is related to the second physical quantity acquired by the second sensor element, wherein a current value of the first physical quantity acquired by the first sensor element is recognized as plausible if a current value of the second physical quantity acquired by the second sensor element lies within the corresponding first reliability range of the first sensor element.

The invention is therefore based on the task of providing an improved method for reliably detecting objects in the surroundings of a motor vehicle.

The task is solved by a method for reliably detecting objects in the surroundings of a motor vehicle in accordance with the features of claim 1.

The task is also solved by a system for reliably detecting objects in the surroundings of a motor vehicle in accordance with the features of claim 8.

### DISCLOSURE OF THE INVENTION

According to an embodiment of the invention, this task is solved by a method for reliably detecting objects in the surroundings of a motor vehicle, wherein the motor vehicle features a plurality of different surroundings sensors, and wherein the method comprises an acquisition of sensor data by at least one of the plurality of different surroundings sensors, for each of the at least one of the plurality of different surroundings sensors respectively detecting objects in the corresponding acquired sensor data, determination of at least one distinctive feature during object detection based on the detected objects, and, for each of the at least one distinctive features, respectively checking the corresponding distinctive feature to reliably detect objects in the surroundings of the motor vehicle.

A sensor, which is also referred to as a detector, measurand or measurement transducer or (measurement) probe, is a technical component that may acquire certain physical or chemical properties and/or the material properties of its surroundings either qualitatively or quantitatively as a measurand.

A surroundings sensor is also understood to be a sensor for sensing conditions in the surroundings, for example, the surroundings of a motor vehicle.

Different surroundings sensors are also understood to mean different types of surroundings sensors or surroundings sensors based on different methods, for example, video cameras, radars, LIDARs or ultrasonic sensors.

The fact that objects are detected in the sensor data also means that objects or things represented in the object data are acquired by object detection or an algorithm for object detection, regardless of their type, wherein the objects may be pedestrians, other motor vehicles, traffic guidance systems or other objects in the surroundings of a motor vehicle, for example.

Distinctive feature is also understood to mean object detection results that may indicate an object, but which shall or should be checked again, in particular to avoid corresponding safety-critical situations when controlling a driver assistance system or a driving function. Such a distinctive feature may be present, for example, if an object is detected in sensor data recorded by a surroundings sensor, but the same object was not also detected in sensor data acquired by other, different surroundings sensors, for example.

The fact that an distinctive feature is checked also means that the object on which the corresponding distinctive feature is based is verified, i.e., it is checked whether the distinctive feature actually represents an object or not.

In this way, the reliability or accuracy when detecting objects in the surroundings of a motor vehicle may be increased, which, in turn, makes it possible to avoid corresponding safety-critical situations when controlling a driver assistance system or a driving function based on the detected objects. In particular, the detection performance or performance of corresponding object detectors may be increased, which, in turn, leads to an improved performance of surroundings perception. This ensures a high detection rate and at the same time reduces the number of falsely detected objects. Furthermore, blind spots of individual object detectors, i.e., situations in which objects may only be detected with difficulty by individual object detectors, may be reliably detected.

Overall, this provides an improved method for reliably detecting objects in a motor vehicle surroundings.

The method may further feature a step of pre-processing the corresponding acquired sensor data for each of the at least one of the plurality of different surroundings sensors, wherein the step of detecting objects in the corresponding acquired sensor data for each of the at least one of the plurality of different surroundings sensors comprises detecting objects in the corresponding pre-processed sensor data.

The fact that the sensor data are pre-processed means that the sensor data are specifically prepared for object detection, wherein, for example, inadequacies of the corresponding sensor may be compensated for.

This may further increase the reliability of detecting objects in the surroundings of the vehicle by optimally adapting or preparing the corresponding data for object detection.

In addition, the step of determining at least one distinctive feature during object detection based on the detected objects may comprise a determination of at least one distinctive feature based on the detected objects and further information describing the situation.

Information describing the situation is understood to mean data representing the corresponding situation, wherein the information may, for example, include context information or information about values of one or more vehicle parameters present in the corresponding situation.

In this way, the reliability when detecting objects in the area surrounding the vehicle may be increased even further by taking into account information about the current situation, for example, current weather conditions, current lighting conditions and/or a current vehicle speed.

Furthermore, the step of determining at least one distinctive feature during object detection based on the detected objects may also comprise applying a machine learning algorithm which is trained to determine distinctive features during object detection based on information about detected objects.

Machine-learning algorithms are based on using statistical methods to train a data processing system such that it may perform a specific task without having been explicitly programmed to do so. The goal of machine learning is to construct algorithms that may learn and make predictions from data. These algorithms create mathematical models with which data may be classified, for example.

This allows the detection of distinctive features to be further optimized and the reliability and accuracy of the detection of distinctive features to be further improved.

The step of, for each of the at least one distinctive features, checking the corresponding distinctive feature may further comprise using an event camera and/or refining an object detection underlying the corresponding distinctive feature and checking the corresponding distinctive feature based on the refined object detection and/or detecting objects in sensor data acquired by another of the plurality of different surroundings sensors to check the corresponding distinctive feature.

An event camera is also understood to be an imaging sensor that reacts to local changes in brightness. Instead of delivering an image sequence with a constant frequency, event cameras only send information from the pixels where the brightness has changed significantly. This allows objects in the surroundings of the vehicle, especially moving objects, to be acquired even better.

Refining an object detection underlying the corresponding distinctive feature and subsequently checking the corresponding distinctive feature based on the refined object detection is further understood to mean that the entire available computer resources are focused or directed to the resolution of the distinctive feature, i.e., conditions of the corresponding data processing system itself are taken into account, alternative, possibly more accurate algorithms for object detection are selected and an attempt is then made to resolve the distinctive feature based on the more accurate algorithm, or that the object detection is adapted in such a way that inconspicuous areas or pixels that are unimportant for the corresponding distinctive feature are omitted or not taken into account in order to save computing time and to be able to concentrate on the resolution of the corresponding distinctive feature.

The fact that objects are detected in sensor data acquired by another of the plurality of different surroundings sensors in order to check the corresponding distinctive feature also means that objects detected in sensor data from a surroundings sensor are verified by checking whether the corresponding objects are also detected in sensor data from at least one other surroundings sensor.

In this way, the reliability in resolving distinctive features and thus also in detecting objects in the surroundings of the vehicle may be increased even further.

In an embodiment, the multiple different surroundings sensors feature a video sensor and/or a LIDAR sensor and/or a radar sensor and/or an ultrasonic sensor.

Video sensors are image-based sensors that record moving scenes and/or may evaluate the acquired sensor data fully automatically.

LIDAR sensors emit laser beams and detect the light scattered back from an object, wherein conclusions may be drawn about the object in question from the backscattered light.

Radar sensors emit electromagnetic waves and detect the waves reflected by an object, wherein conclusions may be drawn about the object in question from the reflected waves.

Ultrasonic sensors, in turn, emit short, high-frequency sound pulses and detect the pulses reflected from an object, wherein conclusions may be drawn about the object in question from the reflected pulses.

The plurality of different surroundings sensors may therefore be sensors that are already integrated into ordinary motor vehicles or are usually already present, such that the method may be achieved without the need for complex and costly conversions.

However, the fact that the plurality of different surroundings sensors feature a video sensor and/or a LIDAR sensor and/or a radar sensor and/or an ultrasonic sensor is only one possible embodiment. In fact, the various surroundings sensors may also feature other sensors that may detect objects in the surroundings of a vehicle, for example, acoustic sensors.

With a further embodiment of the invention, a method for controlling at least one function of a motor vehicle based on objects detected in the surroundings of the motor vehicle is also provided, wherein the method comprises detecting objects in the surroundings of the motor vehicle by a method described above for reliably detecting objects in the surroundings of a motor vehicle and controlling the at least one function of the motor vehicle based on the detected objects.

A function of a motor vehicle is understood here to be a controllable function of the motor vehicle, for example, a driver assistance system or a controllable driving function.

Thus, a method for controlling at least one function of a motor vehicle is provided, which is based on an improved method for reliably detecting objects in the surroundings of a motor vehicle. In particular, this is based on a method for reliably detecting objects in the surroundings of a motor vehicle, with which the reliability or accuracy when detecting objects in the surroundings of a motor vehicle may be increased, which, in turn, may avoid corresponding safety-critical situations when controlling the function of the motor vehicle, for example, a driver assistance system or a driving function based on the detected objects. In particular, the detection performance or performance of corresponding object detectors may be increased, which, in turn, leads to an improved performance of surroundings perception. This ensures a high detection rate and at the same time reduces the number of falsely detected objects. Furthermore, blind spots of individual object detectors, i.e., situations in which objects may only be detected with difficulty by individual object detectors, may be reliably detected.

With a further embodiment of the invention, a system for reliably detecting objects in the surroundings of a motor vehicle is also specified, wherein the motor vehicle features a plurality of different surroundings sensors, and wherein the system is designed to acquire sensor data by means of the at least one of the plurality different surroundings sensors, wherein the system features a detection unit for each of the at least one of the plurality of different surroundings sensors, which is designed to detect objects in the corresponding acquired sensor data, and wherein the system further features a determination unit, which is designed to determine at least one distinctive feature during object detection based on the detected objects, and a checking unit, which is designed to check the corresponding distinctive feature for each of the at least one distinctive features in order to reliably detect objects in the surroundings of the motor vehicle.

This provides an improved system for the reliable detection of objects in the surroundings of a motor vehicle. In particular, the reliability or accuracy of detecting objects in the surroundings of the vehicle may be increased, which, in turn, means that corresponding safety-critical situations may be avoided when controlling a driver assistance system or a driving function based on the detected objects. In particular, the detection performance or performance of corresponding object detectors may be increased, which, in turn, leads to an improved performance of surroundings perception. This ensures a high detection rate and at the same time reduces the number of falsely detected objects. Furthermore, blind spots of individual object detectors, i.e., situations in which objects may only be detected with difficulty by individual object detectors, may be reliably detected.

The system may further feature, for each of the at least one of the plurality of different surroundings sensors, a respective pre-processing unit which is configured to pre-process the corresponding acquired sensor data, wherein, for each of the at least one of the plurality of different surroundings sensors, the detection unit is configured to detect objects in the corresponding pre-processed sensor data. This may further increase the reliability of detecting objects in the surroundings of the vehicle by optimally adapting or preparing the corresponding data for object detection.

In addition, the determination unit may be designed to determine the at least one distinctive feature based on the detected objects and other information describing the situation. In this way, the reliability when detecting objects in the area surrounding the vehicle may be increased even further by taking information about the current situation, for example, current weather conditions, current lighting conditions and/or a current vehicle speed, into account.

Furthermore, the determination unit may be designed to determine the at least one distinctive feature by applying a machine learning algorithm which is trained to determine distinctive features during object detection based on information about detected objects.

Information about detected objects is understood here as data representing the corresponding detected objects.

This allows the detection of distinctive features to be further optimized and the reliability and accuracy of the detection of distinctive features to be further improved.

The checking unit may further be designed to utilize an event camera for checking the corresponding distinctive feature for each of the at least one distinctive features and/or to refine an object detection on which the corresponding distinctive feature is based and to check the corresponding distinctive feature based on the refined object detection and/or to check the corresponding distinctive feature by detecting objects in sensor data acquired by another of the plurality of different surroundings sensors. In this way, the reliability in resolving distinctive features and thus also in detecting objects in the surroundings of the vehicle may be increased even further.

In an embodiment, the multiple different surroundings sensors feature a video sensor and/or a LIDAR sensor and/or a radar sensor and/or an ultrasonic sensor. Therefore, the plurality of different surroundings sensors may be sensors that are already integrated into ordinary motor vehicles or are usually already present, such that the system may be achieved without the need for complex and costly conversions.

However, the fact that the plurality of different surroundings sensors feature a video sensor and/or a LIDAR sensor and/or a radar sensor and/or an ultrasonic sensor is only one possible embodiment. In fact, the various surroundings sensors may also feature other sensors that may detect objects in the surroundings of a vehicle, for example, acoustic sensors.

With a further embodiment of the invention, a system for controlling at least one function of a motor vehicle based on objects detected in the surroundings of the motor vehicle is also provided, wherein the system features a receiver unit for receiving information about objects detected in the surroundings of the motor vehicle, wherein the objects have been detected by a system described above for reliably detecting objects in the surroundings of a motor vehicle, and a control unit which is designed to control the at least one function based on the information provided.

Information about objects detected in the surroundings of the vehicle is understood to mean data representing the corresponding detected objects.

Thus, a system for controlling at least one function of a motor vehicle is disclosed, which is based on an improved system for reliably detecting objects in the surroundings of a motor vehicle. In particular, this is based on a system for reliably detecting objects in the surroundings of a motor vehicle, with which the reliability or accuracy of detecting objects in the surroundings of a motor vehicle may be increased, which, in turn, may avoid corresponding safety-critical situations when controlling the function of the motor vehicle, for example, a driver assistance system or a driving function based on the detected objects. In particular, the detection performance or performance of corresponding object detectors may be increased, which, in turn, leads to an improved performance of surroundings perception. This ensures a high detection rate and at the same time reduces the number of falsely detected objects. Furthermore, blind spots of individual object detectors, i.e., situations in which objects may only be detected with difficulty by individual object detectors, may be reliably detected.

In summary, it may be stated that the present invention provides a method for detecting objects in the surroundings of a motor vehicle, with which a high detection rate can be guaranteed and at the same time the number of falsely detected objects may be reduced.

The described embodiments and refinements may be combined with one another as desired.

Further possible designs, refinements and implementations of the invention also include combinations of features of the invention described previously or below with regard to the exemplary embodiments that are not explicitly mentioned.

### BRIEF DESCRIPTION OF THE DRAWINGS

The accompanying drawings are intended to provide a better understanding of the embodiments of the invention. They illustrate embodiments and, in connection with the description, serve to explain principles and concepts of the invention.

Other embodiments and many of the advantages mentioned are shown in the drawings. The illustrated elements of the drawings are not necessarily shown to scale with respect to one another.

The figures show:

FIG. 1 a flowchart of a method for reliably detecting objects in the surroundings of a motor vehicle, according to embodiments of the invention; and

FIG. 2 a schematic block diagram of a system for reliably detecting objects in the surroundings of a motor vehicle, according to embodiments of the invention.

In the figures of the drawings, identical reference numbers denote identical or functionally identical elements, parts or components, unless stated otherwise.

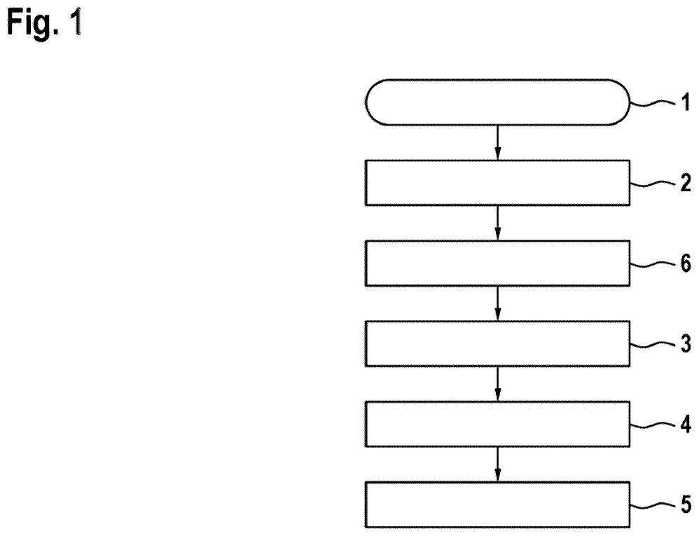

FIG. 1 shows a flow diagram of a method for reliably detecting objects in the surroundings of a motor vehicle 1, according to embodiments of the invention.

In particular, FIG. 1 shows a flow diagram of a method for reliably detecting objects in the surroundings of a motor vehicle 1, according to embodiments of the invention, wherein the motor vehicle features a plurality of different surroundings sensors.

A comprehensive detection of the surroundings of a motor vehicle and in particular of objects, for example, other road users in the surroundings of the motor vehicle, forms the basis for many driver assistance systems and automated driving functions of the motor vehicle. Motor vehicles usually have sensor systems that have the task of detecting objects in their respective detection range. The individual sensor systems each comprise a surroundings sensor and a processing unit, which is designed to analyze data supplied by the surroundings sensor, for example, to detect objects in the data. The surroundings sensors may be video cameras, radars, LIDARs or ultrasonic sensors, for example.

Each of these surroundings sensors is very limited in its respective area of application and, depending on the installation location or current weather conditions, for example, may not be able to provide all the information required about the vehicle surroundings. By combining or merging the information from different environmental sensors, the reliability of the detection of the surroundings of the motor vehicle and thus also the detection of objects in the surroundings of the vehicle may be increased, which, in turn, means that corresponding safety-critical situations may be avoided when controlling a driver assistance system or a driving function based on the detected objects.

In known techniques, objects are detected separately in the sensor data acquired by different surroundings sensors and the individual detection results are then merged using a fusion technique. In particular, in complex, confusing scenarios, however, it is difficult to ensure a high detection rate of objects in the surroundings of the vehicle while keeping the number of incorrectly detected objects low. Consequently, there is a need for improved methods for reliably detecting objects in the surroundings of a vehicle.

FIG. 1 shows a method 1 comprising a step 2 of acquiring sensor data by at least one of the plurality of different surroundings sensors, a step 3 of detecting, for each of the at least one of the plurality of different surroundings sensors, corresponding objects in the corresponding acquired sensor data, a step 4 of determining at least one distinctive feature during object detection based on the detected objects, and a step 5 of, for each of the at least one distinctive feature, respectively checking the corresponding distinctive feature to reliably detect objects in the surroundings of the motor vehicle.

Method 1 has the advantage that the reliability or accuracy of detecting objects in the surroundings of a motor vehicle is increased, which, in turn, means that corresponding safety-critical situations may be avoided when controlling a driver assistance system or a driving function based on the detected objects. In particular, the detection performance or performance of corresponding object detectors may be increased, which, in turn, leads to an improved performance of surroundings perception. This ensures a high detection rate and at the same time reduces the number of falsely detected objects. Furthermore, blind spots of individual object detectors, i.e., situations in which objects may only be detected with difficulty by individual object detectors, may be reliably detected.

Overall, an improved method 1 for reliably detecting objects in a motor vehicle surroundings is thus provided.

In particular, method 1 may therefore be used to achieve improved perception of the surroundings and individual sensor or detection deficiencies may be recognized and then compensated for accordingly.

As FIG. 1 shows, the method 1 further comprises a step 6 of, for each of the at least one of the plurality of different surroundings sensors, respectively pre-processing the corresponding acquired sensor data, wherein the step 3 of, for each of the at least one of the plurality of different surroundings sensors, respectively detecting objects in the corresponding acquired sensor data comprises detecting objects in the corresponding pre-processed sensor data.

The pre-processing of the corresponding sensor data may, for example, include one or more processing steps of applying a semantic segmentation, applying a shape estimator, applying a low-pass filtering or averaging, or time windowing the acquired sensor data.

According to the embodiments of FIG. 1, step 4 of determining at least one distinctive feature during object detection based on the detected objects further comprises determining at least one distinctive feature based on the detected objects and further information describing the situation.

For example, the additional information describing the situation or corresponding metadata may be one or a plurality of features of the speed of a detected object, current light conditions, current weather conditions, situational context information, for example, whether a detected object is at a crosswalk, position data of the vehicle, or data from a navigation system of the vehicle or about a planned route.

According to the embodiments of FIG. 1, the step of determining at least one distinctive feature during object detection based on the detected objects also comprises applying a machine learning algorithm which is trained to determine distinctive features during object detection based on information about detected objects.

The corresponding machine learning algorithm may, for example, be a neural network that has been trained based on corresponding labeled training data.

In particular, the step of determining at least one distinctive feature during object detection may involve the use of an occupancy grid, in particular a two-dimensional occupancy grid. A two-dimensional occupancy grid consists of several cells and, viewed from a bird's eye view, represents a two-dimensional Cartesian grid of the vehicle surroundings, wherein each cell of the occupancy grid may be assigned corresponding coordinates, and wherein the individual detected objects, i.e., the objects detected in at least one of the sensor data acquired by the at least one of the several different surroundings sensors, are assigned to the corresponding coordinates or cells, i.e., occupy these.

Based on the occupied cells of the occupancy grid, distinctive features during object detection or regions of interest may then be determined. For example, if objects are detected in sensor data acquired by different surroundings sensors, a distinctive feature may be present if an object is only detected in sensor data from some of these surroundings sensors, but not in the sensor data from all of these surroundings sensors. If, on the other hand, only objects are detected in sensor data acquired by a surroundings sensor, the corresponding detected objects may represent distinctive features that are to be verified by detecting objects in sensor data acquired by other surroundings sensors.

When checking the distinctive features, the corresponding region of interest may then be focused on.

According to the embodiments of FIG. 1, the step 5 of, for each of the at least one distinctive features, checking the corresponding distinctive feature may comprise applying an event camera to check the corresponding distinctive feature, refining an object detection underlying the corresponding distinctive feature, and checking the corresponding distinctive feature based on the refined object detection and/or detecting objects in sensor data acquired by another of the plurality of different surroundings sensors.

Furthermore, threshold values of an object detection or a corresponding algorithm on which the corresponding distinctive feature is based may also be adjusted in order to achieve improved object detection.

In addition, it is also possible to make optimum or improved use of the resources of the surroundings sensors, for example, by using beam forming techniques to align sensor perception to specific regions of interest, or by increasing the sensor scanning frequency of at least one of the several surroundings sensors for individual specific regions of interest.

Overall, FIG. 1 thus shows a method 1 in which a parallel path to classical multimodal perception techniques is provided, which acts redundantly and may tune or modulate a classical path, for example, if a distinctive feature is determined in the objects detected by a sensor modality, or in which a higher robustness is achieved by comparing the objects detected by a sensor modality with objects detected by other sensor modalities.

According to the embodiments of FIG. 1, the plurality of different surroundings sensors are, in turn, a video sensor, a LIDAR sensor, a radar sensor and an ultrasonic sensor.

The corresponding reliably detected objects may then be used, for example, to control a function of the vehicle, in particular an autonomously driving vehicle. The data from the individual surroundings sensors may also be merged in advance.

For example, the controlling of a function of the motor vehicle may comprise issuing a corresponding warning to a driver of the motor vehicle, intervening in the longitudinal and/or lateral guidance (e.g. initiating emergency braking), or issuing a corresponding warning to other road users, for example, by automatically activating a signal transmitter of the motor vehicle, such as a horn or a vehicle headlight.

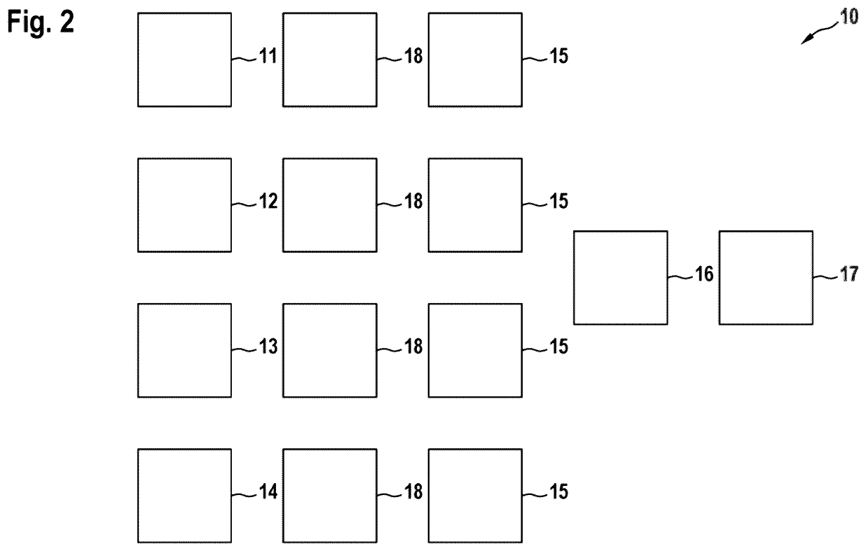

FIG. 2 shows a schematic block diagram of a system for reliably detecting objects in the surroundings of a motor vehicle 10, according to embodiments of the invention.

In particular, FIG. 2 shows a schematic block diagram of a system for reliably detecting objects in the surroundings of a motor vehicle 10, according to embodiments of the invention, wherein the motor vehicle features a plurality of different surroundings sensors 11, 12, 13, 14.

According to the embodiments of FIG. 2, the system 10 is designed to acquire sensor data by means of at least one of the plurality of different surroundings sensors 11, 12, 13, 14, wherein the system 10 features for each of the at least one of the plurality of different surroundings sensors a detection unit 15 designed to detect objects in the corresponding acquired sensor data, and wherein the system 10 further features a determination unit 16, which is designed to determine at least one distinctive feature during object detection based on the detected objects, and a checking unit 17, which is designed to check the corresponding distinctive feature for each of the at least one distinctive features in order to reliably detect objects in the surroundings of the motor vehicle.

The detection unit, the determination unit and the checking unit may each be achieved, for example, based on a corresponding code stored in a memory and executable by a processor.

As FIG. 2 shows, the system further features, for each of the at least one of the plurality of different surroundings sensors 11, 12, 13, 14, a respective pre-processing unit 18 which is configured to pre-process the corresponding acquired sensor data, wherein, for each of the at least one of the plurality of different surroundings sensors, the detection unit 15 is configured to detect objects in the corresponding pre-processed sensor data.

The preprocessing unit may, for example, be achieved based on a corresponding code stored in a memory and executable by a processor.

According to the embodiments of FIG. 2, the determination unit 16 is, in turn, designed to determine the at least one distinctive feature based on the detected objects and other information describing the situation.

In addition, the determination unit 16 is, in turn, also designed to determine the at least one distinctive feature by applying a machine learning algorithm which is trained to determine distinctive features during object detection based on information about detected objects.

According to the embodiments of FIG. 2, the checking unit 17 is again configured to utilize, for each of the at least one distinctive features, an event camera to check the corresponding distinctive feature, to refine an object detection underlying the corresponding distinctive feature, and to check the corresponding distinctive feature based on the refined object detection, and/or to check the corresponding distinctive feature by detecting objects in sensor data acquired by another one of the plurality of different surroundings sensors.

The plurality of different surroundings sensors 11, 12, 13, 14 are, in turn, a video sensor 11, a LIDAR sensor 12, a radar sensor 13 and an ultrasonic sensor 14.

In addition, the system 10 according to FIG. 2 is designed to carry out a method described above for reliably detecting objects in the surroundings of a motor vehicle.

1. A method for reliably detecting objects in the surroundings of a motor vehicle, wherein the motor vehicle includes a plurality of different surroundings sensors, comprising:
acquiring sensor data by at least one of the plurality of different surroundings sensors;
for each of the at least one of the plurality of different surroundings sensors, detecting objects in the corresponding acquired sensor data;
determining at least one distinctive feature during object detection based on the detected objects; and
for each of the at least one distinctive features, checking the corresponding distinctive feature in order to reliably detect objects in the surroundings of the motor vehicle.

2. The method according to claim 1, further comprising:
for each of the at least one of the plurality of different surroundings sensors, pre-processing the corresponding acquired sensor data,
wherein the step of, for each of the at least one of the plurality of different surroundings sensors, respectively detecting objects in the corresponding acquired sensor data comprises detecting objects in the corresponding pre-processed sensor data.

3. The method according to claim 1, wherein the step of determining at least one distinctive feature during object detection based on the detected objects comprises determining at least one distinctive feature based on the detected objects and further information describing the situation.

4. The method according to claim 1, wherein the step of determining at least one distinctive feature during object detection based on the detected objects comprises applying a machine learning algorithm which is trained to determine distinctive features during object detection based on information about detected objects.

5. The method according to claim 1, wherein the step of, for each of the at least one distinctive feature, checking the corresponding distinctive feature comprises applying an event camera to check the corresponding distinctive feature and/or refining an object detection underlying the corresponding distinctive feature and checking the corresponding distinctive feature based on the refined object detection and/or detecting objects in sensor data acquired by another one of the plurality of different surroundings sensors to check the corresponding distinctive feature.

6. The method according to claim 1, wherein the plurality of different surroundings sensors includes a video sensor and/or a LIDAR sensor and/or a radar sensor and/or an ultrasonic sensor.

7. A method for controlling at least one function of a motor vehicle based on objects detected in the surroundings of the motor vehicle, comprising:
detecting objects in the surroundings of the motor vehicle by way of the method for reliably detecting objects in the surroundings of the motor vehicle according to claim 1; and
controlling at least one function of the motor vehicle based on the detected objects.

8. A system for reliably detecting objects in the surroundings of a motor vehicle, comprising:
a plurality of different surroundings sensors, wherein the system is designed to acquire sensor data by way of at least one of the plurality of different surroundings sensors,
for each of the at least one of the plurality of different surroundings sensors, a respective detection unit which is designed to detect objects in the corresponding acquired sensor data,
a determination unit which is designed to determine at least one distinctive feature during object detection based on detected objects, and
a checking unit which is designed to check the corresponding distinctive feature for each of the at least one distinctive features in order to reliably detect objects in the surroundings of the motor vehicle.

9. The system according to claim 8, further comprising:
for each of the at least one of the plurality of different surroundings sensors, a respective preprocessing unit which is designed to preprocess the corresponding acquired sensor data,
wherein, for each of the at least one of the plurality of different surroundings sensors, the detection unit is configured to detect objects in the corresponding preprocessed sensor data.

10. The system according to claim 8, wherein the determination unit is designed to determine the at least one distinctive feature based on the detected objects and further information describing the situation.

11. The system according to claim 8, wherein the determination unit is designed to determine the at least one distinctive feature by applying a machine learning algorithm which is trained to determine distinctive features during object detection based on information about detected objects.

12. The system according to claim 8, wherein the checking unit is designed to utilize, for each of the at least one distinctive features, an event camera for checking the corresponding distinctive feature and/or to refine an object detection underlying the corresponding distinctive feature and to check the corresponding distinctive feature based on the refined object detection and/or to check the corresponding distinctive feature by detecting objects in sensor data acquired by another one of the plurality of different surroundings sensors.

13. The system according to claim 8, wherein the plurality of different surroundings sensors include a video sensor and/or a LIDAR sensor and/or a radar sensor and/or an ultrasonic sensor.

14. A system for controlling at least one function of a motor vehicle based on objects detected in the surroundings of the motor vehicle, comprising:
a receiver unit configured to receive information about objects detected in the surroundings of the motor vehicle, wherein the objects have been detected by the system for reliably detecting objects in the surroundings of the motor vehicle according to claim 8, and
a control unit which is designed to control the at least one function based on the provided information.
